(19) United States
(12) Patent Application Publication
(10) Pub. No.: US 2026/0063151 A1
(43) Pub. Date: Mar. 5, 2026

(54) HYDRAULIC CONTROL OF PLATE-FORM DESIGN

(71) Applicant: Schaeffler Technologies AG & Co. KG, Herzogenaurach (DE)

(72) Inventors: Maximilian Haas, Bühl (DE); Matthias Grenzhäuser, Bühl (DE)

(73) Assignee: Schaeffler Technologies AG & Co. KG, Herzogenaurach (DE)

(21) Appl. No.: 19/107,033

(22) PCT Filed: Aug. 3, 2023
(86) PCT No.: PCT/DE2023/100574

§ 371 Date: Feb. 27, 2025

(30) Foreign Application Priority Data
Aug. 30, 2022 (DE) 10 2022 121 840.6

(51) Int. Cl. F15B 13/08

(52) U.S. Cl. CPC F15B 13/081; F15B 13/0821; F15B 13/0853; F15B 13/086; F15B 13/0871; F15B 13/0889

(57) ABSTRACT

The disclosure relates to a hydraulic control unit of plate-form design, having a control plate arrangement which includes at least two control plates between which an intermediate element is arranged, which has apertures and bears with a first sealing face against a first control plate and with a second sealing face against a second control plate (4). In order to improve the hydraulic control functionally and/or in terms of production, an electrical conductor device is incorporated into the intermediate element

The invention relates to a hydraulic control of plate-form design, having a control plate arrangement which comprises at least two control plates, between which an intermediate element is arranged which has apertures and bears with a first sealing face against a first control plate and with a second sealing face against a second control plate.

A control system having at least two channel-guiding components and an intermediate plate arranged between the two channel-guiding components is known from the German patent application DE 10 2014 210 301 A1, which has at least one active layer and at least one single-layer spacer plate. A hydraulic control unit of plate-form design is known from the German patent application DE 10 2020 109 659 A1, comprising at least one first control plate having a plurality of fluid channels and a second control plate having a plurality of fluid channels and an intermediate plate arranged between the first control plate and the second control plate, wherein the intermediate plate has recesses to connect fluid channels of the first control plate to fluid channels of the second control plate, wherein the intermediate plate has an intermediate plate core made of metal, wherein the intermediate plate core has at least partial regions that are coated by galvanization, wherein the galvanized partial regions have a layer formed from a metal that has a lower hardness than the metal from which the intermediate plate core is formed. A hydraulic control of plate-form design is known from the German patent application DE 10 2012 214 291 A1, having a control plate arrangement comprising at least two control plates, between which an intermediate element is arranged which has apertures and bears with a first surface against a first control plate and with a second surface against a second control plate, wherein the first and/or the second surface of the intermediate element has elevations/depressions which are connected in a form-fitting manner to depressions/elevations provided in/on the first and/or the second control plate.

The object of the invention is to improve a hydraulic control of plate-form design, having a control plate arrangement which comprises at least two control plates, between which an intermediate element is arranged which has apertures and bears with a first sealing face against a first control plate and with a second sealing face against a second control plate, in terms of production and/or functionality.

This object is achieved in a hydraulic control of plate-form design, having a control plate arrangement which comprises at least two control plates, between which an intermediate element is arranged which has apertures and bears with a first sealing face against a first control plate and with a second sealing face against a second control plate, by an electrical conductor device incorporated into the intermediate element. The control plates are designed in a similar way to conventional control plates of a hydraulic control system. The sealing faces must meet high requirements regarding tightness. The sealing faces are advantageously designed in such a way that unwanted leakage of hydraulic medium between the intermediate element and the control plates is reliably prevented. The apertures are used, for example, to provide hydraulic passages between individual hydraulic channels in the control plates. Due to the incorporated electrical conductor device, the intermediate element performs a dual function. This advantageously eliminates the need for separate fastening means for attaching the electrical conductor device to the control plate arrangement. Particularly advantageously, fastening means, in particular screws, which are used to fasten the intermediate element between the two control plates, can also be used to fasten the electrical conductor device incorporated in the intermediate element.

A preferred exemplary embodiment of the hydraulic control is characterized in that the electrical conductor device is surrounded by a plastic material which provides the two sealing faces on the intermediate element. In addition, the plastic material surrounding the electrical conductor device also provides electrical insulation between individual conductors of the electrical conductor device. The plastic material is preferably selected so that it has a low degree of creep behavior. This prevents, in particular, the plastic material used to form the two sealing faces on the intermediate element from exhibiting undesirable viscoelastic behavior between the two control plates. The plastic material can be a thermoplastic or a thermoset plastic material. One of the advantages of the plastic material is that it adapts to any unevenness in the control plates and closes off unwanted leakage paths.

A further preferred exemplary embodiment of the hydraulic control is characterized in that the electrical conductor device is formed from a metallic material and has at least one region which, alternatively or in addition to an electrical conductor function, performs a reinforcing function in the plastic material. Depending on the design of the electrical conductor device, it is possible that the reinforcement function is fulfilled solely by areas of the electrical conductor device that also perform an electrical conductor function. The reinforcement can significantly strengthen the intermediate element.

A further preferred exemplary embodiment of the hydraulic control is characterized in that the electrical conductor device is designed as a lead frame. The lead frame makes it possible to design the electrical conductor device with a large number of electrical conductors. In addition, the lead frame can be produced in large quantities in a cost-effective manner. The lead frame is preferably made of a material that is a good electrical conductor. To achieve the reinforcement function described above, the material from which the lead frame is made is not only electrically conductive, but also sufficiently stable and rigid.

A further preferred exemplary embodiment of the hydraulic control is characterized in that the at least one region having the reinforcing function is formed from a stamping waste material which originates from the production of electrical conductors from the lead frame. It is accepted that more plastic material is required for the overmolding than is needed for the overmolding of the electrical conductor device alone. Here, the stamping waste can be used particularly advantageously to reinforce the intermediate element. Electrically effective connections between electrical conductors and stamping waste sections in the lead frame are advantageously severed in order to ensure proper functioning of the electrical conductor device.

A further preferred exemplary embodiment of the hydraulic control is characterized in that at least one through hole is provided in the lead frame, which provides a hydraulic resistance in the control plate arrangement. This advantageously further increases the functionality of the hydraulic control. The through hole for providing the hydraulic resistance is advantageously arranged in an electrically irrelevant region of the electrical conductor device.

A further preferred embodiment of the hydraulic control is characterized in that the intermediate element having the electrical conductor device is fastened to the control plate arrangement between the two control plates with the same fastening means with which the two control plates are also fastened to one another. The fastening means are, for example, screws. Additional fastening means for attaching the electrical conductor device to the control plate arrangement can thus be omitted.

A further preferred exemplary embodiment of the hydraulic control is characterized in that at least one valve solenoid fastened to the control plate arrangement is connected to the electrical conductor device. The valve solenoid is advantageously attached to one of the two control plates. The functionality of the hydraulic control is further increased by the at least one valve solenoid.

A further preferred exemplary embodiment of the hydraulic control is characterized in that at least one solenoid fastened to the control plate arrangement and/or one displacement sensor fastened to the control plate arrangement are connected to the electrical conductor device. This further increases the functionality of the hydraulic control. In addition, assembly, in particular the connection of the solenoid and/or the displacement sensor, is considerably simplified.

The invention further relates to a control plate arrangement, in particular a control plate, and/or an intermediate element, in particular a lead frame, for a hydraulic control system as described above. The parts mentioned can be dealt with separately.

Further advantages, features and details of the invention are apparent from the following description, in which various exemplary embodiments are described in detail with reference to the drawing. In the drawings:

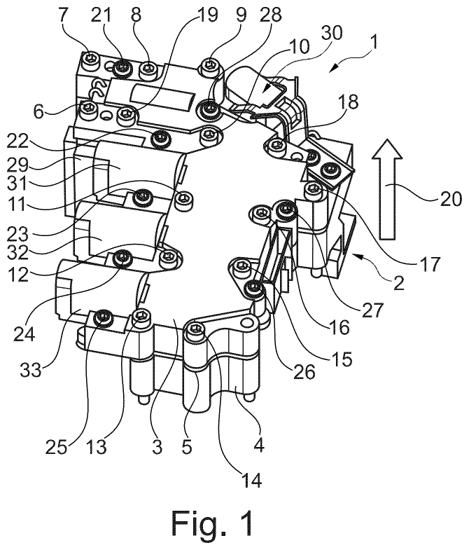

FIG. 1 shows a perspective view of a hydraulic control having a control plate arrangement comprising two control plates, between which an intermediate element is clamped, into which an electrical conductor device is incorporated;

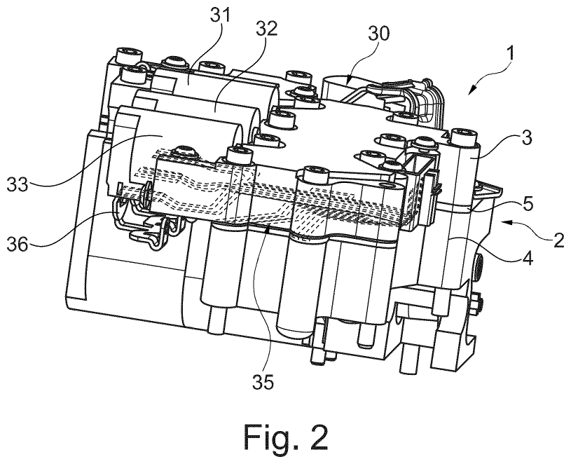

FIG. 2 shows the hydraulic control from a different perspective and partially transparently in order to make the electrical conductor device incorporated into the intermediate element visible;

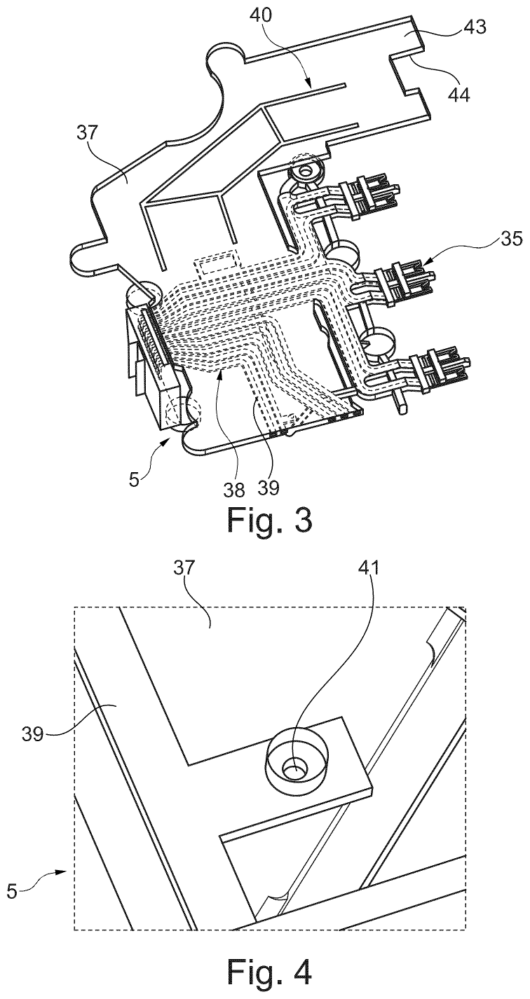

FIG. 3 shows only the electrical conductor device in a perspective and transparent representation; and

FIG. 4 shows an enlarged detail of FIG. 3 with a hydraulic resistance provided in the electrical conductor device.

In FIGS. 1 and 2, a hydraulic control 1 having a control plate arrangement 2 is shown in different perspectives and partially transparently. The control plate arrangement 2 comprises a first or, in FIGS. 1 and 2, upper control plate 3 and a second, in FIGS. 1 and 2, lower control plate 4. An intermediate element 5 is clamped between the two control plates 3 and 4.

In FIG. 2, the partially transparent representation of the control plate arrangement 2 illustrates that an electrical conductor device 35, shown independently in FIG. 3, is incorporated into the intermediate element 5 between the two control plates 3 and 4. The intermediate element 5 with the electrical conductor device 35 incorporated therein is firmly clamped between the two control plates 3 and 4 by means of a total of fourteen screws 6-19.

An upper sealing face of the intermediate element 5, designated with 43 in FIG. 3, bears against the control plate 3. A lower sealing face of the intermediate element 5, designated with 44 in FIG. 3, bears against the control plate 4.

The hydraulic control 1 further comprises a solenoid 30 equipped with a displacement sensor 29. In addition, the hydraulic control 1 comprises three valve solenoids 31, 32 and 33. An insulation displacement contact 36 can be seen in FIG. 2. The insulation displacement contact 36 engages the valve solenoid 33 from below for electrical contact. Plug contacts for electrically contacting the electrical conductor device 35 can be inserted from below, as indicated by the arrow 20 in FIG. 1.

In FIG. 3, only the electrical conductor device 35 is shown in a perspective view. The electrical conductor device 35 is formed from a lead frame 38 which is surrounded by a plastic material 37. The electrical conductor device 35 is preferably produced by overmolding the lead frame 38 with the plastic material 37.

The lead frame 38 provides electrical conductors 39 in the electrical conductor device 35. The electrical conductors 39 additionally provide a reinforcement function in the plastic material 37 of the intermediate element 5.

In addition, the lead frame 38 can comprise at least one region 40 which only performs a reinforcing function in the plastic material 37. In this case, stamping waste material which is produced in the stamping grid 38 during the production of the electrical conductors 39 can advantageously be used to provide the region 40 with the reinforcement function.

In FIG. 4 it can be seen that a through hole 41 is provided in one of the electrical conductors 39. The through hole 41 advantageously provides a hydraulic resistance in the intermediate element 5. As can be seen in FIG. 4, the through hole 41 extends both through the conductor 39 and through the plastic material 37 surrounding the electrical conductor 39.

In FIG. 1, a total of eight circled screws 21 to 28 are indicated, which, in another embodiment of the control plate arrangement 2, fasten an alternative embodiment of an electrical conductor device in FIG. 1. These circled screws 21 to 28 can be omitted in the claimed embodiment of the control plate arrangement 2 with the electrical conductor device 35 incorporated into the intermediate element 5.

Due to the electrical conductor device 35 being integrated into the intermediate element 5 between the two control plates 3 and 4, the electrical conductor device 35 can be technically better connected to the control plate arrangement 2. Contacts of the displacement sensor 29 and the solenoid 30 are advantageously located in the same plane as the electrical conductor device 35, which is also called the lead frame.

In addition, the contacting of the electrical conductor device 35 is simplified. A plug contact for electrically contacting the valve solenoids 31 to 33 can be rotated by one hundred and eighty degrees compared to a conventional design, as indicated by the arrow 20 in FIG. 1. This makes assembly significantly easier because it no longer has to be carried out blind by a worker.

All electrical contacts are located in or near the sealing plane between the control plates 3 and 4 and the intermediate element 5. This advantageously allows for short electrical conductor tracks 39 to be realized. Complex bending operations during the production of the lead frame 38 are thus avoided.

### LIST OF REFERENCE SIGNS

1 Hydraulic control
2 Control plate arrangement
3 Control plate
4 Control plate
5 Intermediate element
6 Screw
7 Screw
8 Screw
9 Screw
10 Screw
11 Screw
12 Screw
13 Screw
14 Screw
15 Screw
16 Screw
17 Screw
18 Screw
19 Screw
20 Arrow
21 Circled screw
22 Circled screw
23 Circled screw
24 Circled screw
25 Circled screw
26 Circled screw
27 Circled screw
28 Circled screw
29 Displacement sensor
30 Solenoid
31 Valve solenoid
32 Valve solenoid
33 Valve solenoid
35 Electrical conductor device
36 Insulation displacement contact
37 Plastic material
38 Lead frame
39 Electrical conductor
40 Region
41 Through-hole
43 Sealing face
44 Sealing face

1. A hydraulic control unit of plate-form construction, comprising:
a control plate arrangement having:
at least two control plates between which an intermediate element is arranged, the intermediate element having apertures and bears with a first sealing face against a first control plate of the at least two control plates and with a second sealing face against a second control plate of the at least two control plates and an electrical conductor device is configured into the intermediate element.

2. The hydraulic control unit according to claim 1, wherein the electrical conductor device is surrounded by a plastic material which provides the first sealing face and the second sealing face on the intermediate element.

3. The hydraulic control unit according to claim 2, wherein the electrical conductor device is formed from a metallic material and has at least one region, which functions as an electrical conductor function, and/or a reinforcement of the plastic material.

4. The hydraulic control unit according to claim 3, wherein the electrical conductor device is a lead frame.

5. The hydraulic control unit according to claim 4, wherein the at least one region functioning as the reinforcement is formed from a stamping waste material from a production process of electrical conductors from the lead frame.

6. The hydraulic control unit according to claim 4, wherein the at least one through hole is provided in the lead frame, the at least one through hole providing a hydraulic resistance in the control plate arrangement.

7. The hydraulic control unit according to claim 4, wherein the intermediate element having the electrical conductor device is fastened to the control plate arrangement between the two control plates with the a same fastening means with which the two control plates are also fastened to one another.

8. The hydraulic control unit according to claim 4, wherein at least one valve solenoid fastened to the control plate arrangement electrically connected to the electrical conductor device.

9. The hydraulic control unit according to claim 4, wherein at least one valve solenoid fastened to the control plate arrangement and/or one displacement sensor fastened to the control plate arrangement are is connected to the electrical conductor device.

10. (canceled)

11. A hydraulic control unit of plate-form construction, comprising:
at least two control plates defining a control plate arrangement,
an intermediate element arranged between the at least two control plates, the intermediate element having:
a plurality of apertures,
an electrical conductor device overmolded with a plastic material, the plastic material forming:
a first sealing face bearing against a first control plate of the at least two control plates,
a second sealing face bearing against a second control plate of the at least two control plates.

12. The hydraulic control unit of claim 11, further comprising a through hole extending through both the electrical conductor device and the plastic material, the through hole providing a hydraulic resistance.

13. The hydraulic control unit of claim 11, wherein the electrical conductor device is a lead frame.

14. The hydraulic control unit of claim 13, wherein the plastic material of the lead frame further comprises a region reinforced by metal.

15. The hydraulic control unit of claim 13, further comprising a first solenoid fastened to the control plate arrangement and electrically connected to the electrical conductor device.

16. The hydraulic control unit of claim 15, further comprising an insulation displacement contact engaging the first solenoid.

17. The hydraulic control unit of claim 15, further comprising a displacement sensor fastened to the control plate arrangement and electrically connected to the electrical conductor device.

18. The hydraulic control unit of claim 17, wherein electrical contacts of the displacement sensor and the first solenoid are located on a same plane as the electrical conductor device.

19. The hydraulic control unit of claim 15, further comprising a second solenoid fastened to the control plate arrangement and electrically connected to the electrical conductor device.

20. The hydraulic control unit of claim 19, further comprising a third solenoid fastened to the control plate arrangement and electrically connected to the electrical conductor device.

21. The hydraulic control unit of claim 20, further comprising a fourth solenoid fastened to the control plate arrangement and electrically connected to the electrical conductor device.
